(19) United States
(12) Patent Application Publication
(10) Pub. No.: US 2005/0030663 A1
(43) Pub. Date: Feb. 10, 2005

(54) Servo-track writer

(76) Inventors: Tsuyoshi Yoshizawa, (US); Kiminori Sato, (US)

Correspondence Address: RABIN & Berdo, PC, 1101 14TH STREET, NW, SUITE 500, WASHINGTON, DC, 20005, US

(21) Appl. No.: 10/736,982

(22) Filed: Dec. 17, 2003

(30) Foreign Application Priority Data
Dec. 20, 2002 (JP) 2002-370560
Dec. 20, 2002 (JP) JP PA 2002-270560

(51) Int. Cl. G11B 21/02

(52) U.S. Cl. 360/75

(57) ABSTRACT

Track addresses for respective recording surfaces of a hard disk drive are input from a main controller 122 to pattern generation sections 130 of a pattern generator. The pattern generation sections 130 generate servo patterns corresponding to the track addresses. The generated servo pattern data are temporarily stored in pattern memories 131. A transfer control circuit 132 reads out, in parallel, the servo pattern data in the pattern memories 131 in synchronism with a servo clock. Output signals from the pattern generator 122 are supplied to recording elements of servo heads 113 via write amplifiers 121, and servo patterns are written to the recording surfaces in parallel. As a result, positional deviations between servo-tracks with the same track address due to alignment errors of the head assembly can be corrected, without the need for complicated track management firmware.

### CROSS-REFERENCE TO RELATED APPLICATION

This application claims the benefit of priority of Japanese application number 2002-370560, filed Dec. 20, 2002, the disclosure of which is incorporated herein by reference.

### BACKGROUND OF THE INVENTION

The present invention relates to a servo-track writer. In particular, the invention relates to a servo-track writer for writing a servo pattern to be used for position detection of magnetic heads on magnetic disks.

In magnetic disk devices, data are read and written by causing a head to trace tracks by referring to servo information that is recorded on concentric tracks on a recording surface. A servo-track writer is an apparatus for writing such servo information to magnetic disks in the form of magnetization patterns.

A conventional servo-track writer will now be described. FIG. 1 shows the configuration of a conventional servo-track writer. FIG. 2 is a plan view of a mechanism section 138 shown in FIG. 1.

As shown in FIG. 1, a plurality of magnetic disks 102 are stacked in parallel and fixed to the rotary shaft of a spindle motor 107 and a clock disk 105 is disposed under the magnetic disks 102 and is also fixed to the rotary shaft. The disks 102 and 105 are rotated together by rotation of the spindle motor 107. A plurality of head arms 123 are stacked, and servo heads 113 are attached to the tips of the head arms 123, respectively, so as to be opposed to respective recording surfaces m₁, m₂, . . . , m_{M} of the magnetic disks 102. The other ends of the head arms 123 are fixed to a rotary positioner 114, which is rotatable about a pivot 125. A rotary encoder 116 is attached to the bottom of the rotary positioner 114 and outputs a signal corresponding to a rotation angle.

A position control section 115 is provided for rotation angle control on the rotary positioner 114. The position control section 115 causes each servo head 113 to trace a prescribed track on the associated recording surface of the associated magnetic disk 102 by controlling the rotation of the rotary positioner 114 by performing a feedback control on the basis of the rotation angle signal supplied from the rotary encoder 116.

A clock head 109 is attached to as to be opposed to the recording surface of the clock disk 105. An output of a clock generator 108 that generates a high-accuracy clock signal is supplied to the clock head 109 via a read/write amplifier 120, and a clock signal is written to prescribed tracks of the clock disk 105. A reproduction output of the clock head 109 is supplied to the read/write amplifier 120, which outputs a servo clock signal that is in synchronism with the rotation of the magnetic disks 102.

A pattern generator 112 is a circuit for generating a one-track servo pattern. An output of the pattern generator 112 is supplied to recording elements of the servo heads 113 via a write amplifier 121, whereby the same servo pattern can be written to the recording surfaces in parallel via the servo heads 113, respectively.

Next, the operation will be described. First, the clock disk 105 and a plurality of magnetic disks 102 to be subjected to servo writing are stacked on the rotary shaft of the spindle motor 107. After alignment is performed so that the side faces of the stacked disks 105 and 102 become flush with each other, the disks 105 and 102 are fixed to the spindle motor 107. Then, the spindle motor 107 is rotated.

Subsequently, the clock head 109 records a clock pattern generated by the clock generator 108 on a prescribed, one-circle track of the clock disk 105. Then, the position control section 115 causes each servo head 113 to trace the outermost track (that is, the first write track) by controlling the rotary positioner 114.

Subsequently, the pattern generator 112 generates servo pattern data to be written to the current tracks and outputs the generated data in synchronism with a servo clock. The servo pattern data is input to the write amplifier 121 and converted into a recording current there. A recording current corresponding to the servo pattern data is supplied to the recording elements of the servo heads 113 for the respective recording surfaces, whereby the same servo pattern is recorded in parallel on the recording surfaces of the magnetic disks 102.

Servo writing on the magnetic disks 102 can be performed by repeating the above operation while step-moving the servo heads 113 to the inner end with a prescribed track pitch.

Finally, the magnetic disks 102 for which the servo writing has completed are removed from the rotary shaft of the spindle motor 107 and incorporated into a hard disk drive in an assembling step therefor.

FIG. 3 shows the structure of a main part of concentric servo-tracks that have been written by the servo-track writer. A track address 143 as track address information and other information necessary for head positioning are written on the servo-tracks.

The conventional apparatus described above has a structure such that the head arms 123 are stacked (hereinafter referred to as a head assembly). Alignment is performed on the head assembly when it is assembled, whereby positional deviations of the respective heads 113 are corrected for. However, some positional errors remain because this adjustment work is mainly performed manually.

The conventional servo-track writer has a problem in that servo-tracks with the same track address are written to the respective recording surfaces at positions that may be skewed from each other due to positional deviations between the heads 113 because the servo-tracks are written to the respective recording surfaces in parallel. The deviations may amount to tens of micrometers, which corresponds to tens of tracks in terms of the number of tracks. This increases the head switching time lag of a hard disk drive and hence is a factor of lowering its performance.

One measure for solving the above problem is to determine track deviations for the respective heads 113 in advance and to compensate for the deviations by firmware of the hard disk drive. However, this method has problems in that complicated track management of the firmware makes it difficult to design the firmware, and the device cost is thereby increased.

### SUMMARY OF THE INVENTION

The present invention has been made in view of the above problems of the prior art, and an object of the invention is to provide a servo-track writer for suppressing an increase in the access time of a hard disk drive and dispensing with complicated track management firmware by correcting for positional deviations between servo-tracks of the same track address due to alignment errors of a head assembly.

To attain the above object, the invention provides a servo-track writer which is equipped with magnetic heads that are provided in plural pairs and stacked so as to be opposed to respective recording surfaces of a plurality of stacked magnetic disks, head positioning means for positioning the magnetic heads at prescribed positions of the recording surfaces, respectively, and servo-track writing means for writing servo-tracks one by one on each of the recording surfaces of the plurality of magnetic disks being rotated while the head positioning means performs the positioning, characterized in that the servo-track writing means comprises means for generating, for each track position, track addresses that are given arbitrary offset values for the recording surfaces, respectively; means for generating servo pattern data for the recording surfaces independently on the basis of the track addresses, respectively; and means for writing the servo pattern data to the respective recording surfaces in parallel.

It is preferable that the arbitrary offset values that are given to the respective recording surfaces be determined on the basis of positional deviations of recording elements of the magnetic heads for the recording surfaces, respectively.

It is also preferable that servo-track write start track positions and write end track positions in recording areas of the recording surfaces are offset in accordance with positional deviations of recording elements of the magnetic heads for the recording surfaces, respectively.

### BRIEF DESCRIPTION OF THE DRAWINGS

FIG. 1 shows the configuration of a conventional servo-track writer;

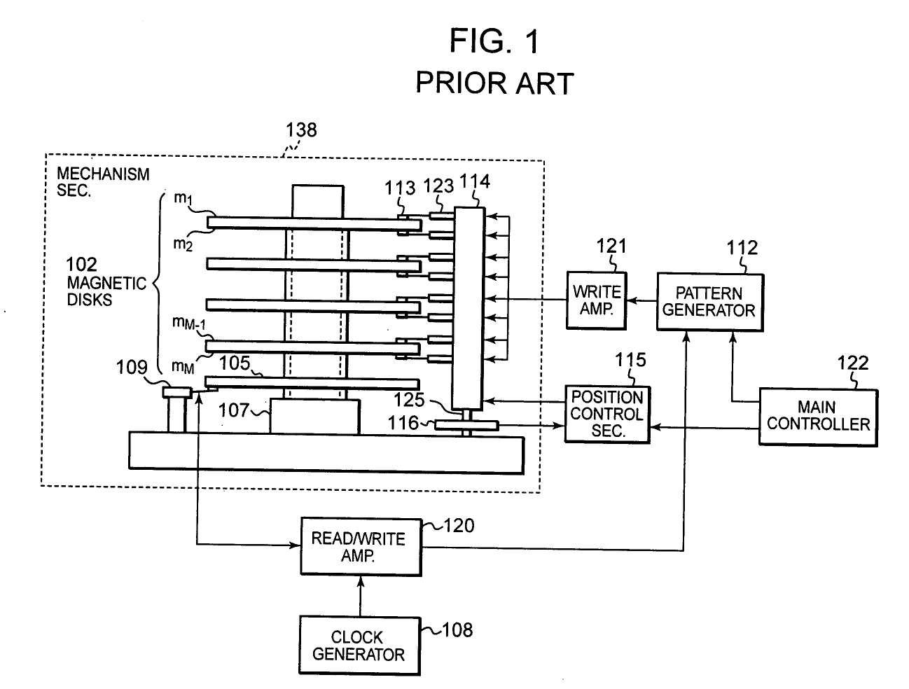

FIG. 2 is a top plan view of a mechanical mechanism section of the conventional servo-track writer;

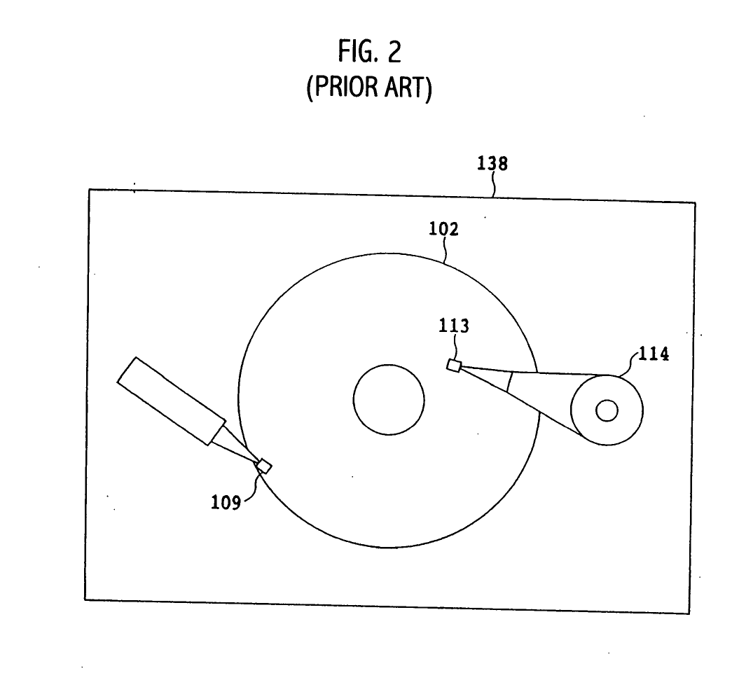

FIG. 3 shows the structure of a main part of servo-tracks that have been written by the servo-track writer;

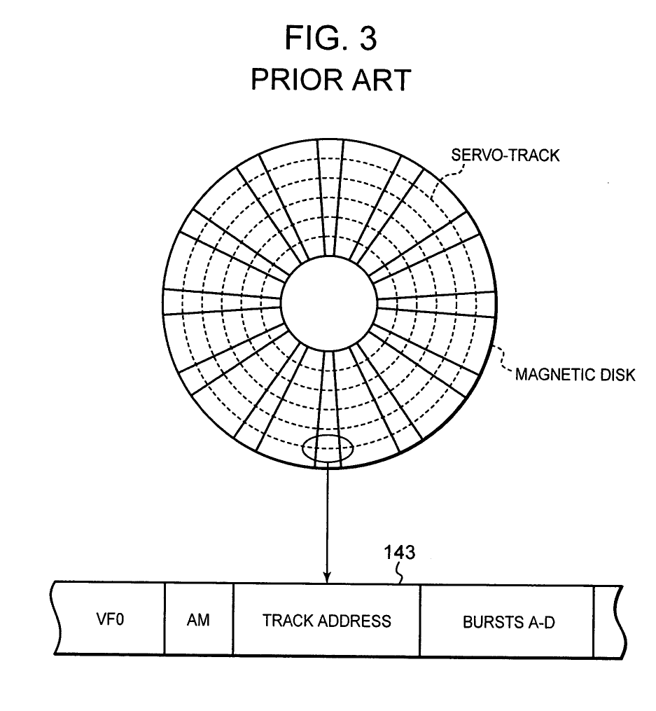

FIG. 4 shows the configuration of a servo-track writer according to an embodiment of the present invention;

FIG. 5 shows the configuration of a pattern generator of the servo-track writer according to the invention;

FIGS. 6A and 6B illustrate a track deviation that is caused by the servo-track writer according to the invention;

FIG. 7 illustrates positional relationships between servo-tracks in the conventional servo-track writer; and

FIG. 8 illustrates positional relationships between servo-tracks in the servo-track writer according to the invention.

### DESCRIPTION OF THE PREFERRED EMBODIMENT

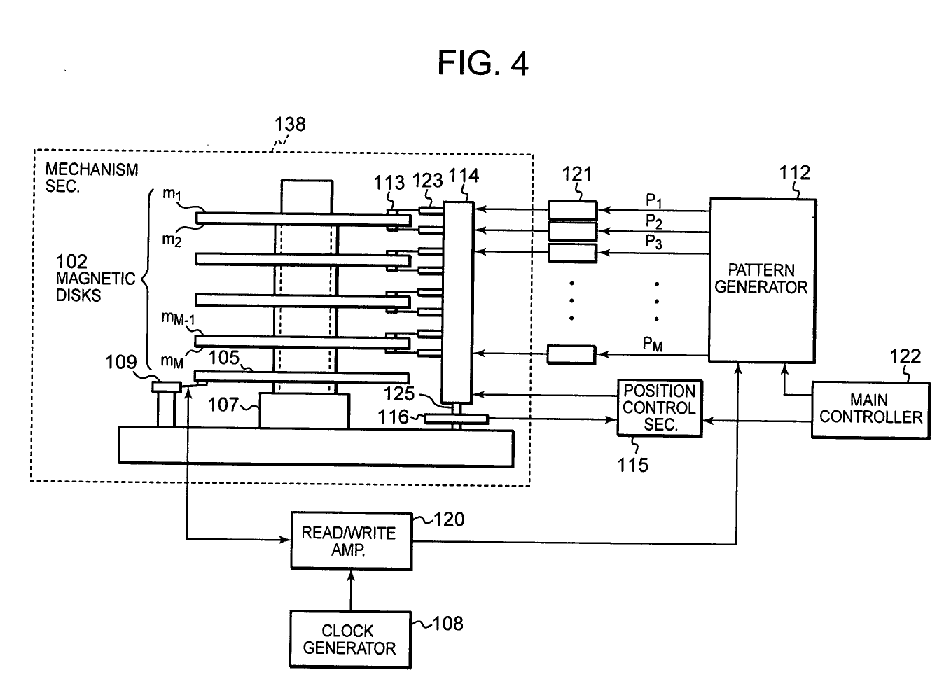

FIG. 4 shows the configuration of a servo-track writer according to an embodiment of the invention.

As shown in FIG. 4, a plurality of magnetic disks 102 are stacked in parallel and fixed to the rotary shaft of a spindle motor 107 and a clock disk 105 is disposed under the magnetic disks 102 and is also fixed to the rotary shaft. The disks 102 and 105 are rotated together by rotation of the spindle motor 107. A plurality of head arms 123 are stacked, and servo heads 113 are attached to the tips of the head arms 123, respectively, so as to be opposite to respective recording surfaces m₁, m₂, . . . , m_{M} of the magnetic disks 102. The other ends of the head arms 123 are fixed to a rotary positioner 114, which is rotatable about a pivot 125. A rotary encoder 116 is attached to the bottom of the rotary positioner 114 and outputs a signal corresponding to a rotation angle.

A position control section 115 is provided for rotation angle control on the rotary positioner 114. The position control section 115 causes each servo head 113 to trace a prescribed track on the associated recording surface of the associated magnetic disk 102 by controlling the rotation of the rotary positioner 114 by performing a feedback control on the basis of the rotation angle signal supplied from the rotary encoder 116.

A clock head 109 is mounted so as to be opposed to the recording surface of the clock disk 105. An output of a clock generator 108 that generates a high-accuracy clock signal is supplied to the clock head 109 via a read/write amplifier 120, and a clock signal is written to prescribed tracks of the clock disk 105. A reproduction output of the clock head 109 is supplied to the read/write amplifier 120, which outputs, to a pattern generator 112, a clock signal (i.e., servo clock) that is in synchronism with the rotation of the magnetic disks 102.

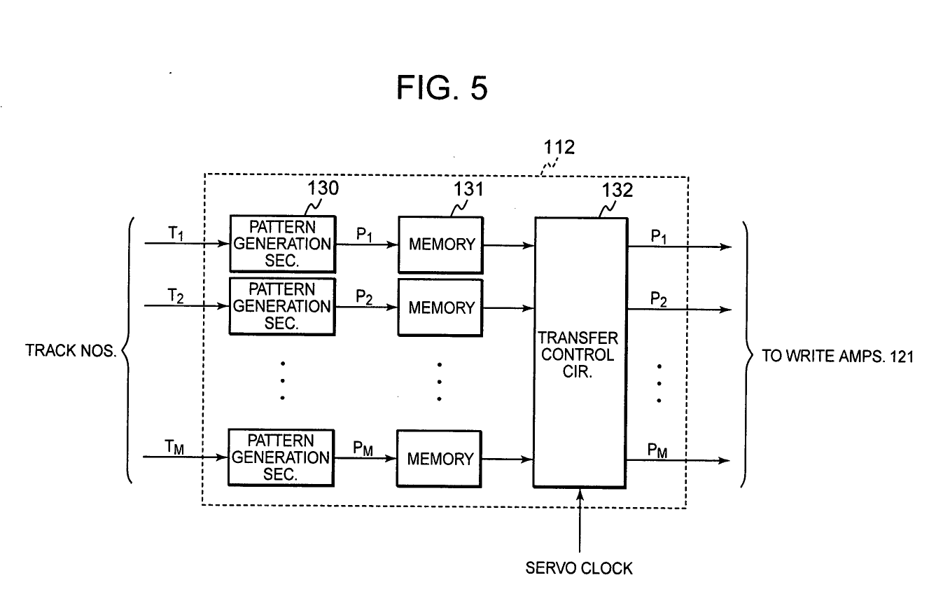

The pattern generator 112 is a circuit for generating servo patterns for the respective recording surfaces. FIG. 5 shows the internal configuration of the pattern generator 112. The pattern generator 112 is composed of M pattern generation sections 130 (M is the same as the number of recording surfaces), M pattern memories 131, and a transfer control circuit 132.

Track addresses T₁, T₂, . . . , T_{M} for the respective recording surfaces are input from a main controller 122 to the respective pattern generation sections 130. Referring to those track addresses, the pattern generation sections 130 generate servo patterns P₁, P₂, . . . , P_{M} corresponding to the respective track addresses. The pattern memories 131 are random access memories for temporarily storing servo pattern data that are generated by the pattern generation sections 130, respectively. The transfer control circuit 132 is a control circuit for reading out, in parallel, the servo pattern data in the pattern memories 131 in synchronism with a servo clock.

Outputs of the pattern generator 112 are supplied to recording elements of the servo heads 113 via write amplifiers 121 that are provided for the respective recording surfaces, whereby servo patterns can be written to the recording surfaces in parallel via the servo heads 113, respectively.

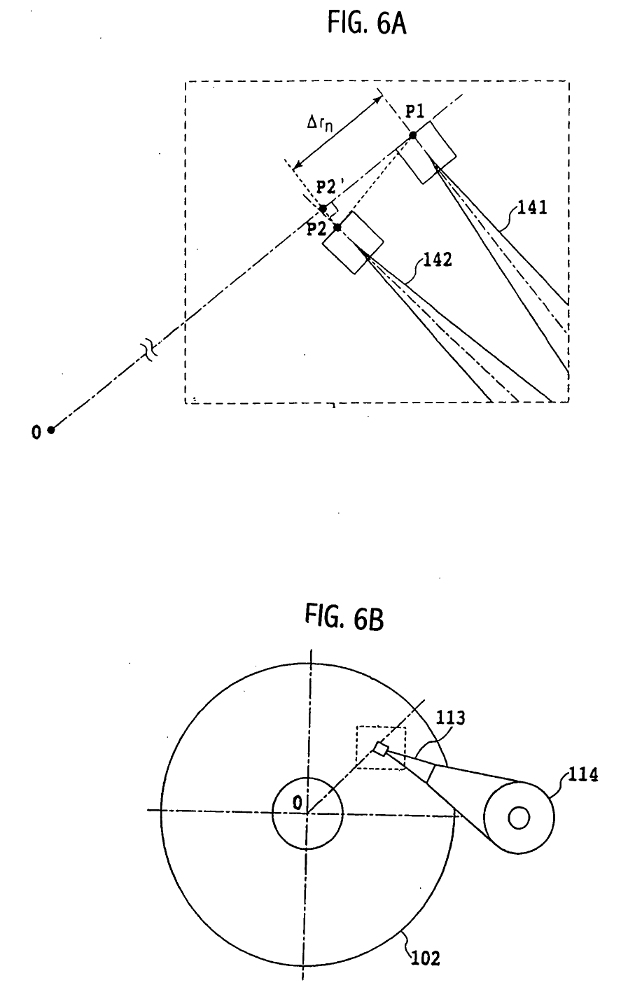

Next, the definitions of a track deviation and a track offset number will be described. FIGS. 6A and 6B illustrate the track deviation. FIG. 6A is an enlarged view corresponding to a dotted-line box in FIG. 6B. These drawings show a positional relationship between a head (i.e., head tip portion) 141 for a recording surface-1 and a head (i.e., head tip portion) 142 for a recording surface-n (n=2 to M) among the servo heads 113, in such a manner that a positional deviation between the heads 141 and 142 is somewhat exaggerated.

Points P₁ and P₂ are the centers of the recording elements of the heads 141 and 142 for recording surface-1 and recording surface-n, respectively, and point O is the rotation center of the disks 102. The absolute value |vector P₁P₂′| of a vector P₁P₂′ that is a component of vector P₁P₂ in the radial direction (i.e., the direction of vector OP₁) is defined as a track deviation Δrₙ of the head 142 for recording surface-n with respect to the head 141 for recording surface-1.

The magnitude of the track deviation varies depending on the rotation angle of the rotary positioner 114 (i.e., the track position). However, the variation is negligible with respect to the track deviation (absolute value) and hence no problems occur even if it is assumed that the track deviation is constant in the recording surfaces.

To determine track deviations, it is necessary to measure positions of the centers of the recording elements for the respective recording surfaces in a plane that is parallel with the recording surfaces in a state such that the servo heads 113 are positioned with respect to prescribed tracks of the magnetic disks 102. This measurement can be performed by using a high-accuracy video sensor or the like.

A track offset number ΔT(n) of the head for recording surface-n (n=2 to M) with respect to the head for recording surface-1 is defined by the following equation:
ΔT(n)=S₁×floor(Δrₙ/T_{W}+0.5) (n=2, 3, . . . , M)
where S₁ has a value “1” if vector P₁P₂′ is in the same direction as vector OP₁ and has a value “−1” if vector P₁P₂′ is opposite in direction to vector OP₁, T_{W} is a track pitch, floor(x) is the maximum integer that does not exceed x, and M is the number of recording surfaces.

That is, the track offset number is the track deviation of the head for recording surface-n (n=2 to M) with respect to the head for recording surface-1 as converted to the number of tracks. The track offset number has a positive value if the track deviation is an outward deviation and has a negative value if the track deviation is an inward deviation.

Next, the operation will be described.

First, track deviations of the servo heads 113 for the respective recording surfaces are determined according to the above definition and track offset numbers ΔT(n) (n=1, 2, 3, . . ., M) are calculated for the respective recording surfaces on the basis of the thus-determined track deviations. It is sufficient to perform this processing only when the positional relationships between the head tip portions of the servo heads 113 for the respective recording surfaces have changed due to head replacement or the like.

Then, the track offset numbers ΔT(n) for the respective recording surfaces are set in the main controller 122. The main controller 122 stores the track offset numbers ΔT(n) in a track offset table (not shown). The track offset number for recording surface-1 is always equal to “0” because of the above definition. Once set, track offset numbers need not be set again every time the apparatus is started because they are stored in a nonvolatile memory (not shown) in the apparatus.

Then, referring to the track offset table, the main controller 122 determines a minimum track address and a maximum track address according to the following equations:
(minimum track address)=min(ΔT(n))
(maximum track address)=N−1+max(ΔT(n))
(n=1,2,3, . . . , M)
where ΔT(n) is a track offset number for recording surface-n, N is the total number of tracks per disk, and M is the number of recording surfaces. Setting the minimum track address and the maximum track address in the above manner allows each recording surface to contain at least N servo-tracks, from one having a track address “0” to one having a track address “N−1.” Although such setting may produce servo-tracks whose track addresses are not greater than “0” or not smaller than “N” depending on the recording surface, a hard disc drive disregards those servo-tracks. The track addresses are set so as to increase as the position goes inward.

Then, a clock disk 105 and a plurality of magnetic disks 102 to be subjected to servo writing are stacked on the rotary shaft of the spindle motor 107. After alignment is performed so that the side faces of the stacked disks 105 and 102 become flush with each other, the alignment-completed disks 105 and 102 are fixed to the spindle motor 107. Then, the spindle motor 107 is rotated.

Subsequently, the clock head 109 records a clock pattern generated by the clock generator 108 on a prescribed, one-circle track of the clock disk 105. The recorded clock signal is reproduced by the clock head 109 and a clock signal (i.e., servo clock) is output from the read/write amplifier 120 in synchronism with the rotation of the magnetic disks 102.

Then, the main controller 122 sets the count of a track counter (not shown) to the minimum track address as an initial value. Then, to move the servo heads 113 to a track position corresponding to the value of the track counter, the main controller 122 outputs a prescribed target position instruction to the position control section 115.

Then, on the basis of the target position instruction, the position control section 115 causes each servo head 113 to trace an outer first track (i.e., a track corresponding to the minimum track address) by controlling the rotation angle of the rotary positioner 114.

Then, the main controller 122 calculates track addresses T₁, T₂, . . . , T_{M} of the respective recording surfaces by adding the track offset numbers for the respective recording surfaces that are stored in the track offset table (not shown) to the value of the track counter, and sets the calculated track addresses in the pattern generator 112.

Subsequently, the pattern generation sections 130 for the respective recording surfaces in the pattern generator 112 generate, on the basis of the input track addresses, servo pattern data P₁, P₂, . . . , P_{M} to be written, and the generated servo pattern data P₁, P₂, . . . , P_{M} are stored in the respective pattern memories 131. Then, the transfer control circuit 132 outputs the servo pattern data P₁, P₂, . . . , P_{M} for the respective recording surfaces with prescribed timing in synchronism with a servo clock. The servo pattern data are input to the write amplifiers 121 for the respective recording surfaces and converted into recording currents there. The recording currents corresponding to the servo pattern data P₁, P₂, . . . , P_{M} are supplied to the recording elements of the servo heads 113 for the respective recording surfaces, respectively, whereby servo patterns are recorded on the respective recording surfaces of the magnetic disks 102.

Then, the main controller 122 increments the count of the track counter (not shown) and the servo heads 113 are moved to the next, inward track position. Servo writing on the magnetic disks 102 is completed by repeating the above operation while step-moving the servo heads 113 to the inner ends with a prescribed track pitch.

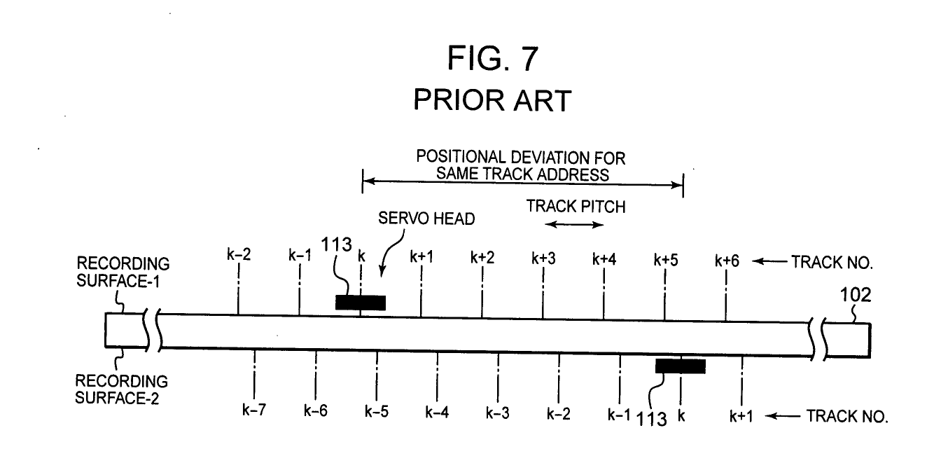

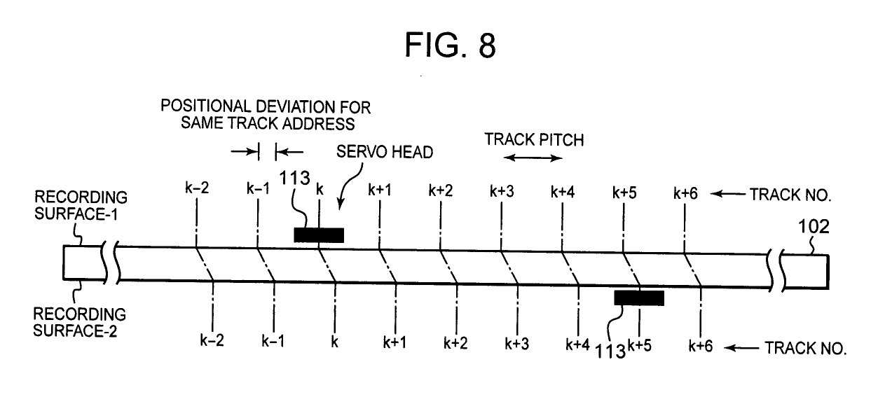

FIGS. 7 and 8 show exemplary positional relationships between servo-tracks that are expected in the conventional servo-track writer and the servo-track writer according to the invention when a positional deviation exists between the servo heads 113 for recording surface-1 (m_{M}) and recording surface-2 (m_{M-1}). In FIGS. 7 and 8, it is assumed that the positional deviation between the servo heads 113 is about five times the track pitch. As seen from FIGS. 7 and 8, in the servo-track writer according to the embodiment (FIG. 8), the positional deviations between the servo-tracks having the same track address can be made much smaller than that in the conventional servo-track writer (FIG. 7).

As described above, in the servo-track writer according to the invention, servo-tracks having the same track address are written so as to be deviated from each other in accordance with positional deviations between the heads for the respective recording surfaces due to alignment errors of the head assembly. Therefore, no large differences occur between the positions of servo-tracks having the same track address of the respective recording surfaces. This reduces the access time of a hard disk drive, and furthermore no complicated track management of firmware is needed. As a result, a servo-track writer can be provided that can be applied to hard disk drives that are superior in cost performance.

It will be understood that the above description of the present invention is susceptible to various modifications, changes, and adaptations, and the same are intended to be comprehended within the meaning and range of equivalents of the appended claims.

1. An improved servo-track writer which is equipped with magnetic heads that are provided in plural pairs and stacked so as to be opposed to respective recording surfaces of a plurality of stacked magnetic disks, head positioning means for positioning the magnetic heads at prescribed positions with respect to the recording surfaces, and servo-track writing means for writing servo-tracks one by one on each of the recording surfaces of the plurality of magnetic disks while the magnetic disks are being rotated and the head positioning means performs positioning, wherein the improvement comprises:
the servo-track writing means includes
means for generating, for each track position, track addresses that are given offset values for the recording surfaces;
means for generating servo pattern data for the recording surfaces independently on the basis of the track addresses; and
means for writing the servo pattern data to the respective recording surfaces in parallel.

2. The servo-track writer according to claim 1, wherein the offset values that are given to the respective recording surfaces are determined on the basis of positional deviations of recording elements of the magnetic heads for the recording surfaces.

3. The servo-track writer according to claim 1, wherein servo-track write start track positions and write end track positions in recording areas of the recording surfaces are offset in accordance with positional deviations of recording elements of the magnetic heads for the recording surfaces.
